(19) United States
(12) Patent Application Publication
(10) Pub. No.: US 2022/0299187 A1
(43) Pub. Date: Sep. 22, 2022

(54) Lighting Device for a Motor Vehicle, and Method for Producing Such a Lighting Apparatus

(71) Applicants: HELLA GmbH & Co. KGaA, Lippstadt (DE); temicon GmbH, Dortmund (DE)

(72) Inventors: Martin MÜGGE, Geseke (DE); Christian SMARSLIK, Lippstadt (DE); Mike BÜLTERS, Dortmund (DE); Jonathan GEUKES, Dortmund (DE)

(21) Appl. No.: 17/837,592

(22) Filed: Jun. 10, 2022

Related U.S. Application Data
(63) Continuation of application No. PCT/EP2020/084522, filed on Dec. 3, 2020.

(30) Foreign Application Priority Data
Dec. 10, 2019 (DE) 102019133693.7

(51) Int. Cl. F21S 43/239; F21S 43/245; F21V 8/00

(52) U.S. Cl. CPC F21S 43/239; F21S 43/245; G02B 6/0043; G02B 6/002; F21V 2200/20

(57) ABSTRACT

A lighting apparatus for a motor vehicle comprises a light source to produce light, a planar light guide into which the light produced by the light source enters at least partially, the light guide having an output surface from which the light emerges at least partially, and a plurality of microstructure elements arranged on the output surface of the light guide to deflect the light emerging from the output surface of the light guide.

### CROSS REFERENCE TO RELATED APPLICATIONS

This application is a continuation of International Application No. PCT/EP2020/084522, filed on Dec. 3, 2020, which claims priority under 35 U.S.C. § 119 to Application No. DE 102019133693.7 filed on Dec. 10, 2019, the entire contents of which are hereby incorporated by reference.

### TECHNICAL FIELD

The present disclosure relates to a lighting apparatus for a motor vehicle.

### BACKGROUND

When designing signal functions for motor vehicles, such as, for example, daytime running lights and turn signal lights at the front of the vehicle or in the headlights, as well as tail lights, brake lights, turn signal lights, backup lights and fog tail lights in the rear lights, well-known and common optical systems, such as reflectors, lenses and light guides are the systems that are frequently used. In the case of light guides, both rod-shaped light guides and panel-shaped or sheet-like light guides are used, depending on the design and size of the light function. Incandescent lights still often tend to be used as the light sources, for example, for inexpensive lights in small cars or as an entry-level variant of the rear lights in mid-range vehicles, while LED technology has prevailed for more complex rear lights and headlights.

A lighting apparatus of the aforementioned type is known from DE 10 2012 103 997 A1. The lighting apparatus described therein may comprise a rod-shaped or planar light guide into which the light of a light emitting diode (LED) can be injected. On one side, the light guide has a plurality of microstructure elements, which deflect the light such that the light emerges from the opposite side. The center-to-center distance between two neighboring microstructures may be, for example, in a range between 0.1 mm and 0.5 mm.

These microstructure elements, which are known from the prior art, generate a bilateral extraction of light, so that about 50% of the light is radiated to a side, where the light cannot be used for the desired function, such as, for example, a signal function.

With advancing technological development and higher requirements on the design of rear lights and headlights, additional features, requirements and technologies will increasingly become the focus of attention. For example, this trend can be seen in the design and implementation of light functions with smaller, separate light emitting elements. In particular, this trend can be clearly seen in the example of the tail light in rear lights, which use to this end OLED technology as a possibility of designing precision light emitting elements. In addition, the homogeneous illumination of light surfaces can be seen as an important trend for all vehicle manufacturers. The homogeneous illumination constitutes, in a way, a quality feature and is, therefore, very important for the vehicle manufacturer in order to demonstrate to buyers of vehicles the corresponding competence and care in the development of lights and/or signal functions. Here, too, the OLED technology provides outstanding homogeneity in the design of the illuminating OLED surfaces.

An example of a lighting apparatus for a motor vehicle with at least one organic light emitting diode (OLED) is known from WO 2005/025275 A1.

The OLED technology for light emitting elements has continued to evolve over the past 20 years, in order to meet the special requirements for use in automobiles. Examples of such requirements are the temperature range, mechanical stresses, such as vibration, shock and shake tests, and the service life. In the meantime rigid, glass-based light emitting elements have been installed as the first OLED technology in individual lights, mostly in luxury vehicles or special vehicle variants that are produced in small numbers. Furthermore, these rigid, glass-based light emitting elements show incomparably homogeneous illuminations in versions of light emitting elements that at the same time are themselves extremely flat, for example, about 1 mm. The OLED is technologically comparable to the semiconductor chip of an LED, but designed as a planar element. A light emitting layer is produced by means of different layers of different materials, applied to a thin pane of glass and contacted at the edges, and excited, in order to let the entire surface emit uniform and homogeneous light. This combination of new technology and the desired homogeneity of illumination in conjunction with a new type of flat light emitting element is what drives the choice of OLEDs in vehicle lights. The vehicle manufacturer likes to use new technologies, especially if they are also known from other sectors, such as the consumer sector, in order to use such new technologies for advertising and, in so doing, to present themselves as technological leaders. The technology is restricted only by the limited colors of light, because only red OLEDs are currently available on the automotive market, by the low luminance or rather brightness and by the very high costs of an OLED.

### SUMMARY

These restrictive aspects of OLED technology mean that the use of alternative options for producing homogeneous light emitting surfaces or, more specifically, light emitting elements that have the potential to generate a similar appearance is desirable.

Therefore, the problem, on which the present disclosure is based, is to provide a lighting apparatus of the aforementioned type that is more effective and, in particular, can ensure the most homogeneous illumination possible of a surface of the lighting apparatus. Furthermore, a method for producing such a lighting apparatus shall be disclosed.

This object is achieved, according to the present disclosure, by a lighting apparatus of the aforementioned type having microstructure elements arranged on the output surface of the light guide. The microstructure elements can be used to ensure a homogeneous emission of the light and, thus, a homogeneous illumination of the output surface.

It can be provided that the microstructure elements are designed such that light, deflected by the microstructure elements, essentially more than 80%, preferably more than 90%, emerges from the output surface. As a result, the effectiveness of the lighting apparatus can be increased, because significantly more light emerges from the output surface than, for example, from the surface opposite the output surface.

It is possible for the adjacent microstructure elements to have a center to center distance, preferably varying stochastically, between 0.03 mm and 0.20 mm. As a result, the microstructure optics, formed by the microstructure elements, can no longer be resolved as a structure when viewed with the human eye, so that the output surface appears to be diffusely and homogeneously illuminated.

Furthermore, the microstructure elements may be designed such that a forward directed extraction of the light from the light guide takes place. As a result, the injected light can be emitted mainly in the direction that is also decisive for fulfilling a signal function and the desired illumination.

It can be provided that the light guide has an incidence surface for the light from the at least one light source. The incidence surface is designed, in particular, as an end face of the light guide. In particular, in the case of a panel-shaped light guide, the light can be injected directly at an edge or an end face of the light guide.

It is possible for the light guide to have a curved or angled light feed section for the light from the at least one light source and/or an input optics for the light from the at least one light source. By providing a curved or angled light feed section or an input optics as a particular alternative, it is possible to offer options for adaptation to a large number of different integrations, for example, in a rear light or a headlight. In this case, an input optics can be used, for example, to straighten or parallelize the incidence light.

It can be provided that the thickness of the light guide decreases in the direction, perpendicular to the output surface, in the direction of propagation of the light in the light guide, in particular, starting from the incidence surface. In this case, for example, a linear reduction in the wall thickness can be provided, or an adapted reduction in the wall thickness with a non-linear progression. As a result, in particular, the thickness of the light guide can be made thin, for example, with a thickness between 1 mm and 2 mm, while at the incidence surface a sufficiently large wall thickness, for example, with a thickness between 2 mm and 4 mm, is made possible for positioning the light source. As a result, it is possible to achieve an appearance that is similar to that of a thin organic light emitting diode (OLED). Moreover, in particular, the microstructure elements and the change in thickness of the light guide over the length of the light guide can correlate with one another, in order to generate a homogeneous illumination of the output surface.

It is possible for the at least one light source to be in the form of a light emitting diode or a laser diode. For example, in contrast to OLED elements, any color of light, such as, for example, red, dark red, yellow, white, blue, green, cyan or any other color, can be achieved by using conventional light emitting diodes as light sources. Furthermore, corresponding light outputs of the light emitting diodes can also provide signal functions with a higher light intensity, such as a brake light or a turn signal light. The available light emitting diodes that have different light outputs, such as, for example, light emitting diodes with low luminous fluxes between 1 lm and 2 lm, light emitting diodes with average luminous fluxes between 5 lm and 10 lm, light emitting diodes with high luminous fluxes between 15 lm and 25 lm or light emitting diodes with very high luminous fluxes between 30 lm and 100 lm or in white up to more than 250 lm, can be used to achieve a desired brightness or, more specifically, luminance and light intensity, in order to provide any common signal function, such as, for example, a tail light, a brake light, a turn signal light or a daytime running light. In this case the daytime running light, the brake light and the turn signal light are special designs that cannot be implemented with today's OLED technology.

It can be provided that a first plurality of microstructure elements is designed differently from a second plurality of microstructure elements, so that different substructures of the microstructure are formed. The substructures may be, for example, a background pattern and/or a dividing line and/or a text and/or a logo. In this case, for example, the height of the microstructure may vary. The substructures can become visible to a viewer in the illumination of the light guide. The substructures may be a recurring background pattern that fills the area, such as, for example, hexagons, honeycombs, rectangles, circles, triangles or the like. The substructures can also form dividing lines, in order to indicate a segmentation of the light emitting surface. Furthermore, the substructures may be fonts, texts or logos, such as, for example, a logo of the vehicle manufacturer. If sections of the output surface are changed in this way, it is also possible to generate desired brightness differences in the illumination. As a result, it is possible to achieve, for example, three dimensional lighting effects.

It is possible for the microstructure elements to be part of an injection molded part. The result is a cost-effective and simple production of the microstructure elements.

It can be provided that the lighting apparatus comprises a first substrate, which serves as a light guide, and a second substrate, which has the microstructure elements. In this context the two substrates are joined to one another, in particular, by interlocking or by welding, such that the microstructure elements abut the output surface of the first substrate serving as a light guide. Although such a design is usually associated with the loss of the flat design of the system, it offers better optimization possibilities due to the division of the functions into an optics-free light guide and a substrate, which is positioned in front of the light guide and is provided with the microstructure elements. In this case, the joining of the first substrate, which serves as a light guide, to the second substrate is to be designed such that the microstructure elements touch the output surface of the light guide. As a result, it can be achieved that the light injected into the light guide is guided by the microstructure elements and passes through the second substrate in order to exit into a desired emitting area provided for this purpose. In addition, additional microstructure optics can be provided on the light output side of the second substrate. The necessary joining or rather contact between the two substrates can take place by interlocking or by welding, such as, for example, by ultrasonic welding or laser welding, the two substrates. During the interlocking and/or the welding process, it may be useful to prestress at least one substrate, for example, in the form of a slightly curved surface of the second substrate, which is pressed against the light guide by the fastening process in order to ensure that the microstructure comes into contact with the output surface of the light guide.

It is possible for the lighting apparatus to comprise more than one planar light guide with more than one output surface. In order to produce a signal function of a headlight and/or a rear light of a vehicle or any lighting apparatus, such as, for example, a planar interior light of a vehicle, it may be useful from a functional viewpoint to provide more than one light guide with more than one output surface such that the light guides can be arranged side-by-side or one above the other or offset from one another, in particular, also overlapping, in order to produce a desired appearance.

It can be provided that the lighting apparatus is designed as a tail light or as a brake light or as a turn signal light or as a daytime running light or as an interior light of the motor vehicle.

It is possible for the light guide and/or the two substrates to be flat or curved. The light guide and/or the two substrates can be designed substantially two dimensionally as a panel or as, for example, a cylindrically curved surface or as a three dimensionally curved surface. In this context the light guide and/or the two substrates can be any size and have any contour and shape, such as, for example, a square, rectangular, polygonal, circular or oval shape, or can be provided with any contouring.

The microstructure elements are produced by an injection molding process, in particular, together with the light guide or the second substrate. For example, there are diffuser films or light guiding films that are provided with microstructure optics. If the light guide or the second substrate had to be provided with such a film, then this would prove to be a complex and cost-intensive production step, in particular, because of the associated bonding process and the previous cutting of the film to size. Furthermore, there would also be the risk that the film would detach itself again or that the adhesive layer would have a negative impact on the properties of the system or that qualitative, primarily visible, defects would occur in mass production.

These disadvantages are avoided by manufacturing the microstructure elements together with the light guide or the second substrate by an injection molding process so that this approach gives rise to considerable manufacturing advantages. In this case the microstructure can be injection molded directly onto each injection molded light guide or each injection molded second substrate by using a correspondingly shaped tool insert for a plastic injection molding tool. For this purpose, an adapted mold concept as well as adapted temperatures and parameters may be required for the injection molding process in order to allow the injected plastic polymer compound to fill the mold or, more specifically, the cavities provided in the mold, on the one hand, and to enable the polymer compound to penetrate into the very fine microstructure in the mold wall, on the other hand, in order to mold the microstructure in high quality and true to shape.

It is possible for templates of the microstructure elements to be produced by a lithographic process and to be transferred to an injection molding tool, in particular, by an electroplating process.

### BRIEF DESCRIPTION OF THE DRAWINGS

The disclosure is explained in more detail below with reference to the attached drawings. The drawings show in:

FIG. 1 in schematic form a side view of a first implementation of a lighting apparatus, according to the disclosure, with a first implementation of a light guide;

FIG. 2 in schematic form a side view of the lighting apparatus, according to FIG. 1, with an exemplary beam path of the light coming from a light source;

FIG. 3 a view, according to the arrow III in FIG. 1;

FIG. 4 in schematic form a side view of a second implementation of a lighting apparatus, according to the disclosure, with the first implementation of a light guide;

FIG. 5 in schematic form a perspective view of a third implementation of a lighting apparatus, according to the disclosure, with a second implementation of a light guide;

FIG. 6 in schematic form a perspective view of a third implementation of a light guide of a lighting apparatus, according to the disclosure;

FIG. 7 in schematic form a perspective view of a fourth implementation of a light guide of a lighting apparatus, according to the disclosure;

FIG. 8 in schematic form a front view of a fourth implementation of a lighting apparatus, according to the disclosure, with a plurality of light guides of the first implementation of a light guide;

FIG. 9 in schematic form a front view of a fifth implementation of a lighting apparatus, according to the disclosure, with a plurality of light guides of the third implementation of a light guide;

FIG. 10 in schematic form a front view of a sixth implementation of a lighting apparatus, according to the disclosure, with a plurality of light guides of the fourth implementation of a light guide;

FIG. 11 in schematic form a front view of a seventh implementation of a lighting apparatus, according to the disclosure;

FIG. 12 in schematic form a side view of an eighth implementation of a lighting apparatus, according to the disclosure;

FIG. 13 in schematic form a side view of the lighting apparatus, according to FIG. 12, with an exemplary beam path of the light coming from a light source;

FIG. 14 in schematic form a side view of the lighting apparatus, according to FIG. 12, in an unassembled state;

FIG. 15 in schematic form a perspective view of a detail of the lighting apparatus, according to FIG. 1.

### DETAILED DESCRIPTION

Identical or functionally identical parts are provided with the same reference numerals and symbols in the figures.

FIG. 1 to FIG. 3 and FIG. 15 show the implementation of a lighting apparatus of the present disclosure, comprising a light source 1 and a light guide 2. As can be seen in FIG. 3, the light source 1 has a plurality of light emitting diodes 3.

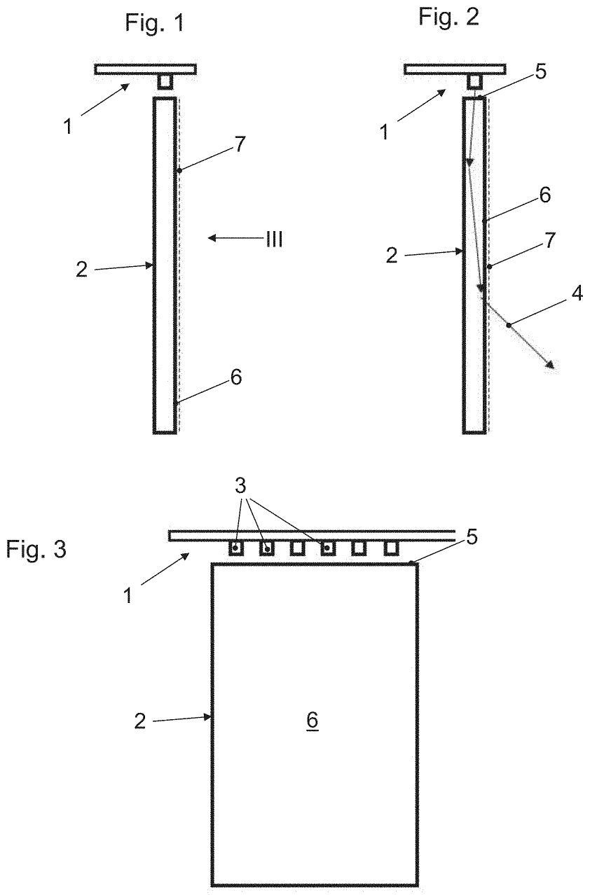

The light guide 2 is designed as a flat panel, where the light 4, coming from the light emitting diodes 3, is injected into an end face, serving as an incidence surface 5. In FIG. 1 and FIG. 2, the right side surface of the light guide 2 serves as an output surface 6 for the light 4.

It is quite possible to inject the light 4 into another narrow side of the light guide 2, for example, into the lower end face in FIG. 1 and FIG. 2 or into the right or left side surface in FIG. 1 and FIG. 2.

Furthermore, the lighting apparatus also comprises a plurality of microstructure elements 7 on the output surface 6 of the light guide 2. In FIG. 1 and FIG. 2 the microstructure elements 7 are indicated by a dashed line. The center to center distance between adjacent microstructure elements 7 can be less than 0.1 mm. As a result, it can be achieved that the microstructure optics, formed by the microstructure elements 7, can no longer be resolved as a structure when viewed with the human eye, so that the output surface 6 appears diffuse.

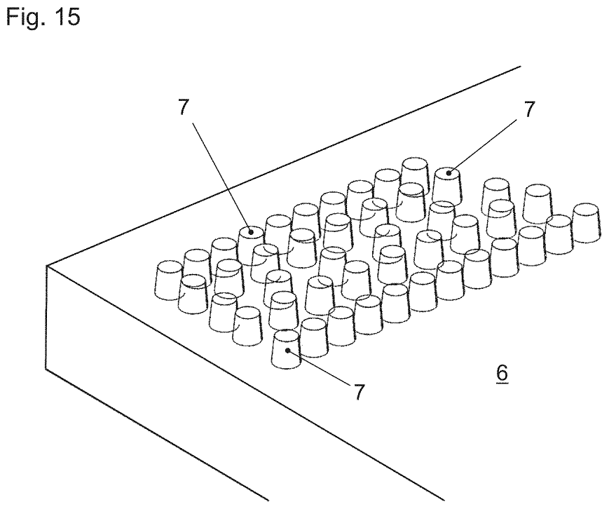

In FIG. 15 the microstructure elements 7 are not shown true to scale, but rather are significantly enlarged. The illustrated microstructure elements 7 have in each case the shape of a truncated cone, extending away from the output surface 6, wherein the microstructure elements 7 taper off, starting from the output surface 6. The base of the truncated cones may have a diameter of about 25 μm. The height of the truncated cones may also have a height of about 25 μm. The cone angle can be between 1° and 5°. The distance between the individual truncated cones on the incidence surface 3 may be between 30 μm and 150 μm; and, in particular, the distance can vary stochastically.

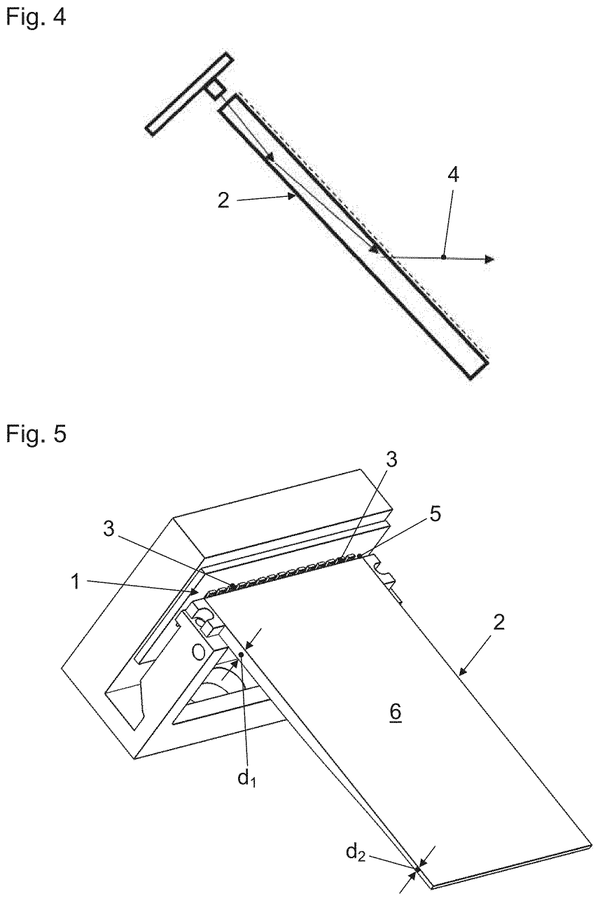

For physical reasons, the maximum of the distribution of light, emerging from the output surface 6, may not be oriented normal to the output surface 6 during extraction. Therefore, FIG. 4 shows a lighting apparatus, in which the light guide 2 is installed at an angle to the vertical. As a result, it can be achieved that the light 4 emerges horizontally from the output surface 6, so that the result is an improved perception and recognizability for a person, who is looking at the rear light of a vehicle from an upper field of vision and, thus, sees the output surface 6 as the surface, facing him.

FIG. 5 shows a light guide 2, the thickness of which changes in the direction of propagation of the light 4 in the light guide 2. In the area of the incidence surface 5, the light guide 2 has a comparable large first thickness d1 of, for example, 2 mm to 4 mm. This thickness d1 should be large enough to allow the light 4 to be fed through the incidence surface 5. A second thickness d2 in the end area of the light guide 2 is significantly smaller, so that the thickness d2 there is only about 1 mm to 2 mm.

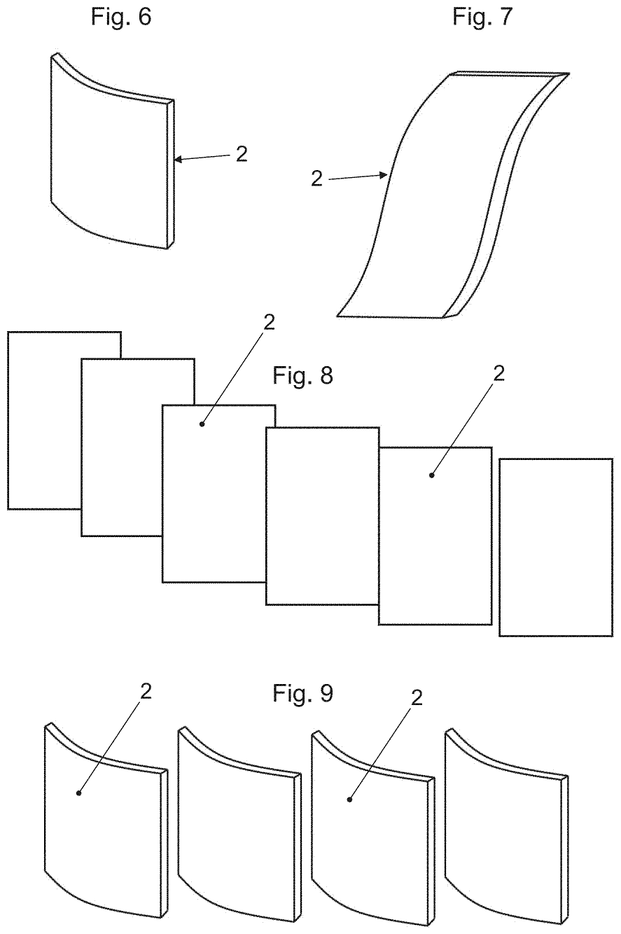

FIG. 6 shows an example of a cylindrically curved light guide 2. FIG. 7 shows an example of a three dimensionally curved light guide 2.

FIG. 8 to FIG. 10 illustrate that a lighting apparatus, according to the disclosure, can have more than one light guide 2. In this case the light guides 2 can be arranged side by side or one above the other or offset from one another, in particular, also overlapping, in order to produce a desired appearance.

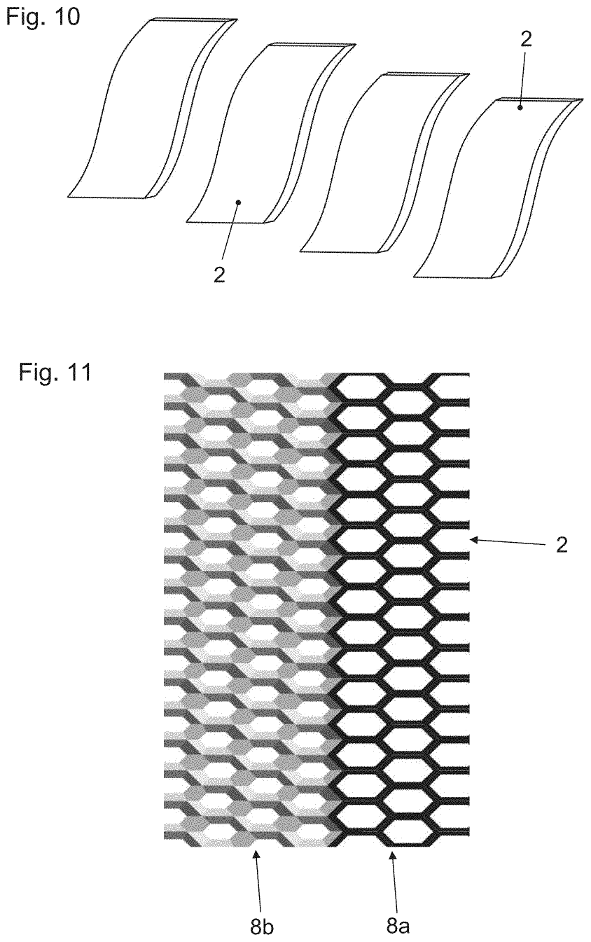

FIG. 11 shows an implementation of the lighting apparatus, in which a first plurality of microstructure elements is designed differently from a second plurality of microstructure elements, so that two different substructures 8a, 8b of the microstructure are formed. In this case the two substructures 8a, 8b, respectively, form structures of hexagons. The substructures 8a, 8b are, in particular, so different from one another that three-dimensional lighting effects are generated. In this case, the substructures 8a, 8b can be implemented, for example, by varying the height of the microstructure or, more specifically, the microstructure elements 7.

It is quite possible to use other geometric elements for the design of the substructures 8a, 8b, instead of a background pattern, consisting of hexagonal shapes. Such geometric elements may be, for example, rectangles, circles, triangles or honeycombs. As an alternative, it is also possible to implement other substructures, such as a dividing line and/or a text and/or a logo, instead of a repetitive background pattern.

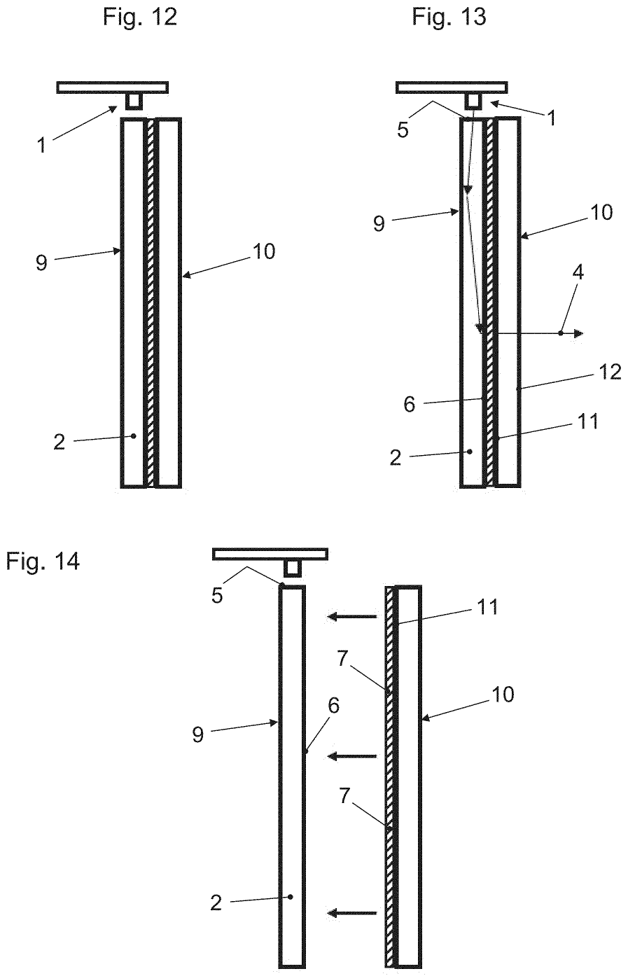

The implementation of a lighting apparatus, according to FIG. 12 to FIG. 14, comprises a first and a second substrate 9, 10, through which the light 4 can pass. In this respect the first substrate 9 serves as a light guide 2, which has an incidence surface 5, which is formed as an upper end face in FIG. 13, for the light 4. On a surface 11, facing the first substrate, the second substrate 10 has microstructure elements 7 for extracting the light 4 from the output surface 6 of the first substrate 9.

In order to enable the extraction, the output surface 6 of the first substrate 9 and the surface 11 of the second substrate 10, on which the microstructure elements 7 are arranged, must abut each other. For this purpose, the two substrates 9, 10 are firmly joined to one another, for example, by interlocking or by welding. FIG. 14 shows the two substrates 9, 10 before the joining process.

If the output surface 6 of the first substrate 9, serving as the light guide 2, and the surface 11 of the second substrate 10, the surface being provided with the microstructure elements 7, lie flush against one another, then the light 4 emerges from the first substrate 9 through the output surface 6 and enters the second substrate 10 through the surface 11. Then the light 4 emerges from the second substrate 10 through the surface 12 opposite the surface 11 that is provided with the microstructure elements 7 (see FIG. 13).

What is claimed is:

1. A lighting apparatus for a motor vehicle, comprising
a light source to produce light;
a planar light guide into which the light produced by the light source enters at least partially, the light guide having an output surface from which the light emerges at least partially; and
a plurality of microstructure elements arranged on the output surface of the light guide to deflect the light emerging from the output surface of the light guide.

2. The lighting apparatus of claim 1, wherein the microstructure elements allow more than 80% of the light to emerge from the output surface.

3. The lighting apparatus of claim 1, wherein the microstructure elements allow more than 90% of the light to emerge from the output surface.

4. The lighting apparatus of claim 1, wherein the microstructure elements have a center-to-center distance varying stochastically between 0.03 mm and 0.20 mm.

5. The lighting apparatus of claim 1, wherein an incident surface of the light guide through which the light produced by the light source enters is an end face of the light guide.

6. The lighting apparatus of claim 1, wherein the light guide has a curved or angled light feed section for the light produced by the light source and/or input optics for the light produced by the light source.

7. The lighting apparatus of claim 1, wherein a thickness of the light guide decreases in a propagation direction of the light in the light guide, starting from the incidence surface, the propagation direction being perpendicular to the output surface.

8. The lighting apparatus of claim 1, wherein the light source comprises a light emitting diode or a laser diode.

9. The lighting apparatus of claim 1, wherein the microstructure elements comprise first microstructure elements and second microstructure elements designed differently from the first microstructure elements such that the first and second microstructure elements form a background pattern, a dividing line, text, and/or a logo.

10. The lighting apparatus of claim 1, wherein the microstructure elements are a component of an injection molded part.

11. The lighting apparatus of claim 1, further comprising a plurality of planar light guides each having an output surface.

12. The lighting apparatus of claim 1, wherein the lighting apparatus is a tail light, a brake light, a turn signal light, a daytime running light, or an interior light of the motor vehicle.

13. The lighting apparatus of claim 1, wherein the light guide is flat or curved.

14. A method for producing the lighting apparatus of claim 1, comprising:
producing the microstructure elements by injection molding, together with the light guide.

15. The method of claim 14, further comprising:
producing templates of the microstructure elements by a lithographic process; and
transferring the templates by an electroplating process to an injection molding tool used to carry out the injection molding.

16. The lighting apparatus of claim 1, further comprising:
a first substrate that serves as the light guide; and
a second substrate containing the microstructure elements, wherein the first and second substrates are joined to one another by interlocking or by welding such that the microstructure elements abut the output surface of the light guide.

17. The lighting apparatus of claim 16, wherein the the first and second substrates are flat or curved.

18. A method for producing the lighting apparatus of claim 16, comprising:
producing the microstructure elements by injection molding, together with the first and second substrates.

19. The method of claim 18, further comprising:
producing templates of the microstructure elements by a lithographic process; and
transferring the templates by an electroplating process to an injection molding tool used to carry out the injection molding.
